(19) United States
(12) Patent Application Publication
(10) Pub. No.: US 2011/0294353 A1
(43) Pub. Date: Dec. 1, 2011

(54) ELECTRICAL CONNECTOR

(76) Inventor: YI-HSING CHUNG, Wugu Township (TW)

(21) Appl. No.: 12/788,327

(22) Filed: May 27, 2010

(51) Int. Cl. H01R 24/00

(52) U.S. Cl. 439/660

(57) ABSTRACT

An electrical connector includes an insulation housing and a plurality of conductive terminals. The housing forms a plurality of barbs at suitable locations for respective engagement with the terminals. Each of the terminals has a side face from which at least one retention projection extends. The retention projection is engageable with and thus retained by the respective barb. Since the retention projection is formed on a side face of the terminal, it improves the overall thickness of the electrical connector and realizes a low profile design of the connector.

### TECHNICAL FIELD OF THE INVENTION

The present invention generally relates to an electrical connector, and more particularly to an electrical connector of low profile.

### DESCRIPTION OF THE PRIOR ART

With the quick progress of technology and science, the size of an electronic product is made compact and thin. As shown in FIG. 1, a conventional electrical connector is shown and generally designated at 1. The electrical connector 1 comprises an insulation housing 10 and conductive terminals 12. Each terminal 12 has a top face on which a retention projection 120 is formed. The retention projection 120 is engageable with and thus retained by the housing 10. Since the retention projection 120 is located atop each terminal 12, the overall thickness of the electrical connector 1 is increased. Consequently, the increased thickness of the electrical connector 1 requires an electronic product that adopts the electrical connector 1 therein to provide a sufficient space for accommodating the electrical connector 1.

### SUMMARY OF THE INVENTION

The primary purpose of the present invention is to provide an electrical connector, which comprises an insulation housing and a plurality of conductive terminals. The housing forms a plurality of barbs at suitable locations for respective engagement with the terminals. Each of the terminals has a side face on which at least one retention projection is formed through stamping. The retention projection is engageable with and thus retained by the respective barb. Since the retention projection is formed on a side face of the terminal, the arrangement of the retention projection on the side of the terminal helps reducing the overall thickness of the electrical connector and realizes a low profile design of the connector.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a structure of a conventional electrical connector for retaining a terminal.

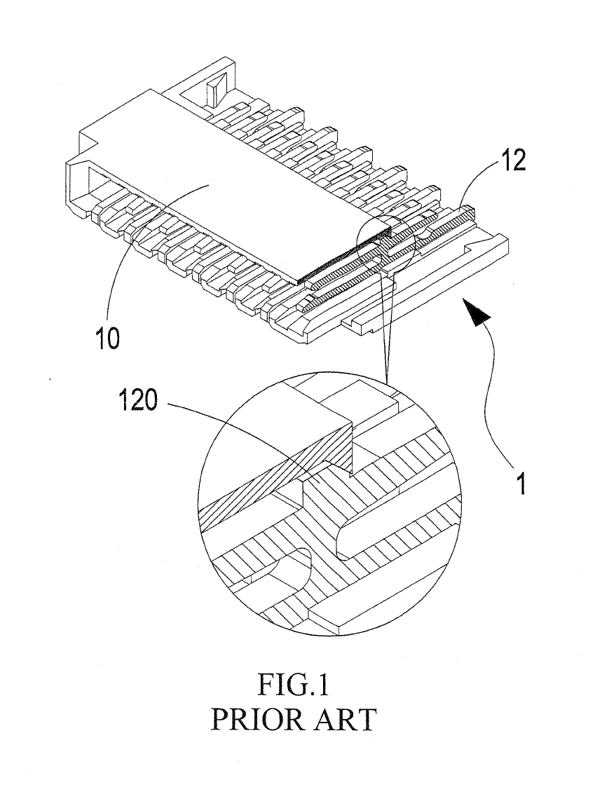

FIG. 2 is a perspective view showing an electrical connector according to a preferred embodiment of the present invention.

FIG. 3 is an exploded view showing the electrical connector according to the present invention.

FIG. 4 is a perspective view showing engagement between a retention projection of a terminal and a corresponding barb of a housing of the electrical connector of the present invention.

FIG. 5 is a perspective view showing a terminal of an electrical connector according to another embodiment of the present invention.

FIG. 6 is a perspective view showing the electrical connector according to the said another embodiment of the present invention in an assembled form.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

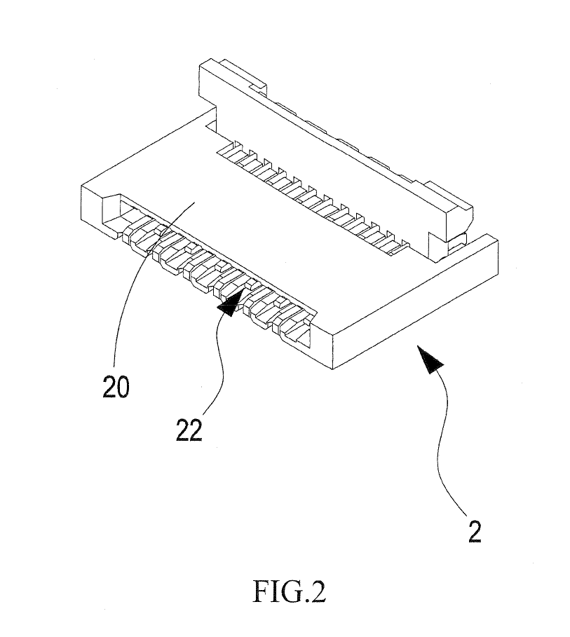

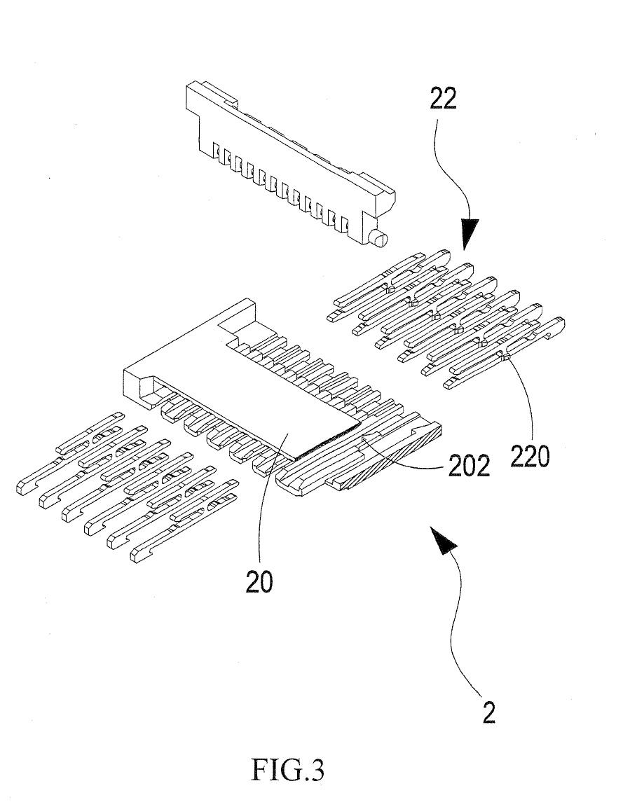

Referring to FIGS. 2 and 3, which show a perspective view and an exploded view of an electrical connector according to a preferred embodiment of the present invention, as shown in the drawings, the electrical connector provided by the present invention, generally designated at 2, comprises an insulation housing 20 and a plurality of conductive terminals 22. The housing 20 forms a plurality of barbs 202 at suitable locations for respectively engaging and retaining the plurality of terminals 22. Each terminal 22 has a side face that forms, through for example stamping, a retention projection 220. The retention projection 220 is engageable with and thus retained by the respective barb 202, for the retention projection 220 is formed on the side face of the terminal 22.

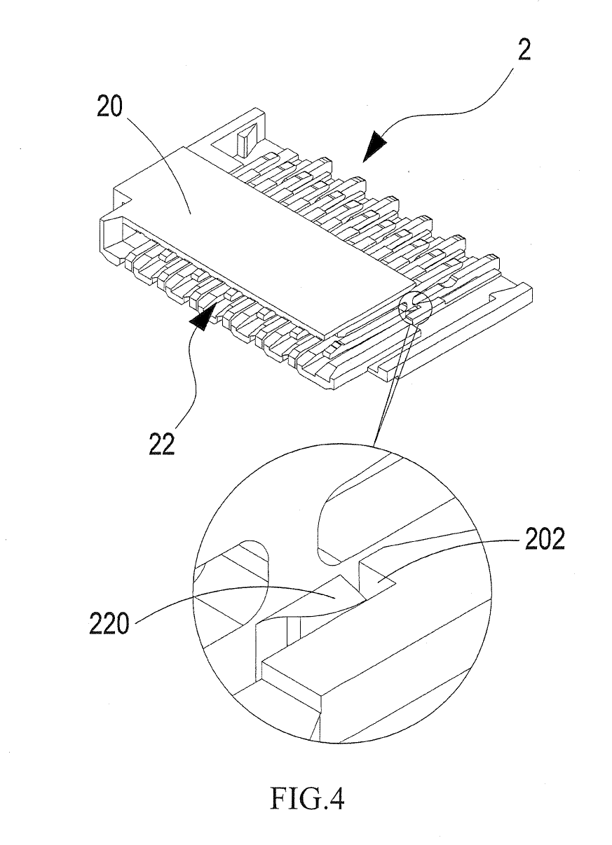

With the structure described above, the operation of the electrical connector of the present invention will be described. Reference being also made to FIG. 4, which shows the engagement between the retention projection and the barb of the housing, as shown in the drawing, the terminals are sequentially mounted into the housing in such a way that the retention projection 220 formed on the side face of each of the terminals 22 gets into engagement with the respective barb 202 of the housing 20. Since the retention projection 220 is located on the side face of the terminal 22, it improves the conventional structural arrangement that the retention projection 220 is located on the top of the terminal 22, and the overall thickness of the electrical connector 2 can be reduced to realize a low profile arrangement.

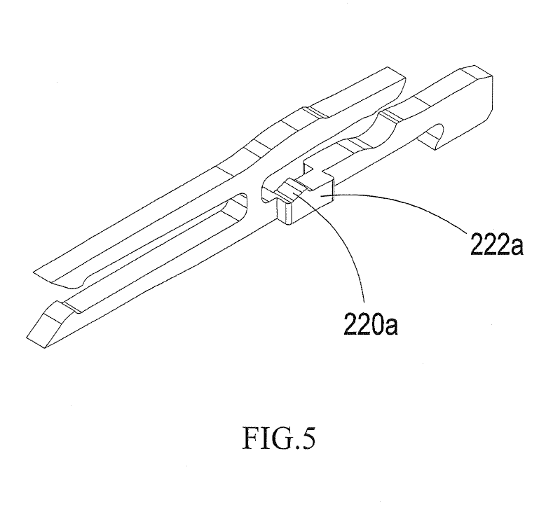

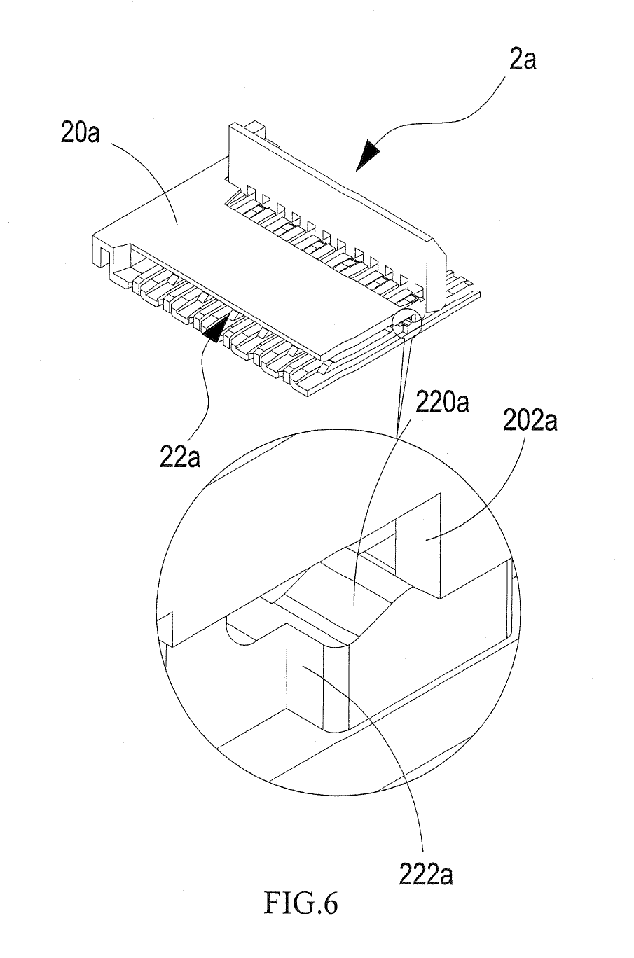

Referring to FIGS. 5 and 6, which show a perspective view of terminal and an assembled condition of an electrical connector according to another preferred embodiment of the present invention, as clearly shown in the drawings, each terminal 22a has a side face from which a projection block 222a extends and a retention projection 220a extends from the projection block 222a. The retention projection 220a is formed on a face of the projection block 222a that opposes a barb 202 formed in a housing 20a. In this way, the engagement can be formed at a location that does not affect the overall thickness of the electrical connector 2a.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1-4. (canceled)

5. An electrical connector comprising:
an insulation housing having a top from which a plurality of barbs extend downwardly;
a plurality of conductive terminals fitted in said insulation housing, each of said conductive terminals having a side face from which a projection block extends and a retention projection extends from said projection block, said retention projection being formed on a top of said projection block that engages with a respective one of said barbs formed in said housing.

6. The electrical connector as claimed in claim 5, wherein said retention projection is formed through stamping.
